(19) United States
(12) Patent Application Publication
(10) Pub. No.: US 2019/0325379 A1
(43) Pub. Date: Oct. 24, 2019

(54) INTELLIGENT INVENTORY MANAGEMENT USING CLEANING MACHINES

(71) Applicant: Fellow, Inc., Burlingame, CA (US)

(72) Inventors: Marco Octavio Mascorro Medina, Burlingame, CA (US); Thavidu Ranatunga, Burlingame, CA (US); Utkarsh Sinha, Burlingame, CA (US); Sivapriya Kaza, Burlingame, CA (US); Jason Hoang, Burlingame, CA (US); Jagadish Mahendran, Burlingame, CA (US); Christopher Yang, Burlingame, CA (US); Zhengqin Fan, Burlingame, CA (US)

(21) Appl. No.: 16/457,647

(22) Filed: Jun. 28, 2019

Related U.S. Application Data
(63) Continuation-in-part of application No. 16/138,758, filed on Sep. 21, 2018, now Pat. No. 10,373,116.
Application No. 16/138,758 is a continuation-in-part of application No. 15/369,812, filed on Dec. 5, 2016, now Pat. No. 10,311,400.
Application No. 15/369,812 is a continuation-in-part of application No. 14/921,899, filed on Oct. 23, 2015, now Pat. No. 9,796,093.
(60) Provisional application No. 62/068,474, filed on Oct. 24, 2014.
(60) Provisional application No. 62/622,000, filed on Jan. 25, 2018.
(60) Provisional application No. 62/561,588, filed on Sep. 21, 2017.
(60) Provisional application No. 62/795,152, filed on Jan. 22, 2019.

(51) Int. Cl. G06Q 10/08; G06K 9/00; G05D 1/02; G05D 1/00; A47L 11/40

(52) U.S. Cl. CPC G06Q 10/087; G06K 9/00671; G05D 1/0246; A47L 2201/04; G05D 1/0088; A47L 11/4061; G05D 2201/0203; G05D 1/0242

(57) ABSTRACT

A system for performing inventory management and cleaning within a commercial facility includes a mobile cleaning vehicle configured to clean a floor of the commercial facility. A computer is in communication with the cleaning vehicle, at least one imaging sensor, a transmitter, and a receiver. The computer is configured to capture inventory images from the at least one imaging sensor and detect inventory by comparing captured inventory images with stored inventory images. Inventory information is determined and a confidence level for the inventory information is determined. At least a portion of the inventory information having a confidence level above a threshold is communicated to the database. The cleaning vehicle may be a semi or fully autonomous cleaning vehicle having wheels and a floor cleaning system.

### CROSS REFERENCE TO RELATED APPLICATION

This application is a continuation-in-part of U.S. patent application Ser. No. 16/138,758 entitled, “Intelligent Inventory Management and Related Systems and Methods” filed Sep. 21, 2018, which in turn is a continuation-in-part of U.S. patent application Ser. No. 15/369,812 entitled, “Intelligent Service Robot and Related Systems and Methods filed Dec. 5, 2016, now U.S. Pat. No. 10,311,400, which in turn is a continuation-in-part of U.S. patent application Ser. No. 14/921,899 entitled “Customer Service Robot and Related Systems and Methods” filed Oct. 23, 2015, now U.S. Pat. No. 9,796,093, which claims the benefit of U.S. Provisional Application Ser. No. 62/068,474 entitled, “Customer Service Robot and System” filed Oct. 24, 2014. U.S. application Ser. No. 16/138,758 also claims the benefit of U.S. Provisional Application Ser. No. 62/622,000 entitled, “Intelligent Inventory Management and Related Systems and Methods” filed Jan. 25, 2018 and U.S. Provisional Application Ser. No. 62/561,588 entitled, “Intelligent Service Robot and Related System” filed Sep. 21, 2017. This application also claims the benefit of U.S. Provisional Application Ser. No. 62/795,152 entitled “Intelligent Inventory Management Using Cleaning Machines” filed Jan. 22, 2019, the entire disclosures of which are incorporated herein by reference.

### FIELD OF THE DISCLOSURE

The present disclosure is generally related to inventory management systems and methods and more particularly is related to inventory management using cleaning machines.

### BACKGROUND OF THE DISCLOSURE

Inventory management in retail and commercial buildings is a complex, time-consuming, and expensive issue. Large stores can carry more than 10,000 items on shelves, and these items must be tagged, tracked, displayed, restocked, and priced on a regular basis to ensure product availability to customers.

Inventory stocking is the process of placing items out on shelves or in displays such that they can be purchased by customers. Restocking is the process of replenishing items that have been purchased, moved, stolen, or damaged. Stocking and restocking are time-consuming tasks, since they normally entail the detailed review of all products for sale. Traditionally, store employees travel each aisle, noting the number and location of depleted or missing items. They gather new inventory from a backroom storage area, then travel each aisle again, replenishing low stock with new inventory. Depending on the store, this process can take dozens of employees and many hours to complete. Often, restocking must be done after a store has closed or late at night. This can leave shelves understocked for long periods during business hours. Additionally, the process can require additional employees working an overnight shift to complete restocking before the opening of the store the next day.

While employees are restocking inventory on shelves, they often must concurrently perform quality assurance checks. Employees ensure that all items are properly located, returning moved and misplaced items to their appropriate areas. Often, this means traveling the entire store in search of misplaced items and subsequently placing the misplaced items in their correct locations. Additionally, employees must also ensure that items are displayed neatly, with price tags and labels visible. Employees also frequently need to make sure that any pricing information displayed is correct. Often, this means checking item prices against periodic or special sales lists and amending incorrect displays. Furthermore, this method of pricing is not dynamic, as it is difficult for retail stores to adjust prices quickly based on supply and demand.

Additionally, many franchise or branch stores are required to stock and display products in a manner determined by a corporate office. Such information is usually displayed in the form of a planogram: a diagram that indicates the placement of products in a shelf and in a store. Planogram compliance can be inaccurate for a number of reasons, including human error in reading the diagram, differences in store layout, inattention to placement details, and changes in product packaging. However, planogram compliance is important to ensure consistency between stores and to present products for sale according to a chosen strategic plan. If stores do not stock and display products accurately, the data upon which corporate offices analyze sales and create strategic placement plans is likely to be inaccurate.

Current solutions to these problems utilize inventory management software, point of sale systems, and tracking devices to manage inventory. However, the implementation of these solutions is largely dependent on data supplied by humans. This data can be inconvenient to collect, time-consuming to gather, and inaccurate. Some solutions include robotic inventory scanners that can be directed down aisles and around shelves in order to electronically manage inventory. However, these robotic scanners may include costly hardware, and may not be financially feasible for many proprietors.

Thus, a heretofore unaddressed need exists in the industry to address the aforementioned deficiencies and inadequacies.

### SUMMARY OF THE DISCLOSURE

Embodiments of the present disclosure provide a system and method for performing inventory management and cleaning within a commercial facility. Briefly described, in architecture, one embodiment of the system, among others, can be implemented as follows. A vehicular system for performing inventory management and cleaning within a commercial facility includes a mobile cleaning vehicle configured to clean a floor of the commercial facility. A computer is in communication with the mobile cleaning vehicle, at least one imaging sensor, a transmitter for sending inventory information to a database, and a receiver for receiving inventory information from a database. The computer has a processor and computer-readable memory and is configured to capture inventory images from the at least one imaging sensor and detect inventory by comparing captured inventory images with stored inventory images. Inventory information is determined and a confidence level for the inventory information is determined. The confidence level may be determined based on at least a type of inventory items detected and a number of inventory items detected. At least a portion of the inventory information having a confidence level above a threshold is communicated to the database.

The present disclosure can also be viewed as providing a system for performing automated inventory management within a commercial facility using a cleaning vehicle. Briefly described, in architecture, one embodiment of the system, among others, can be implemented as follows. The system for performing automated inventory management within a commercial facility using a cleaning vehicle has at least one imaging sensor, a transmitter for sending inventory information to a database, and a receiver for receiving inventory information from a database. A computer is in communication with the at least one imaging sensor, the transmitter, and the receiver. The computer has a processor and computer-readable memory and is configured to capture inventory images from the at least one imaging sensor and detect inventory by comparing captured inventory images with stored inventory images. Inventory information is determined and a confidence level for the inventory information is determined. The confidence level may be determined based on at least a type of inventory items detected and a number of inventory items detected. At least a portion of the inventory information having a confidence level above a threshold is communicated to the database.

The present disclosure can also be viewed as providing methods of inventorying and simultaneously cleaning a commercial facility with a semi or fully autonomous robotic vehicle. In this regard, one embodiment of such a method, among others, can be broadly summarized by the following steps: providing a mobile cleaning vehicle within a commercial facility, the mobile cleaning vehicle being semi or fully autonomous, wherein the mobile cleaning vehicle has a locomotion platform, at least one floor cleaning system, at least one imaging sensor, a transmitter for sending inventory information to a database, a receiver for receiving inventory information from a database, and a computer in communication with the locomotion platform, the at least one imaging sensor, the transmitter, and the receiver, the computer having a processor and computer-readable memory; capturing inventory images with the at least one imaging sensor; detecting inventory information by comparing captured inventory images with stored inventory images; determining a confidence level for the inventory information, wherein the confidence level is determined based on at least a type of inventory items detected and a number of inventory items detected; and communicating at least a portion of the inventory information having a confidence level above a threshold to the database.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is an illustration of a system for performing inventory management and cleaning within a commercial facility, in accordance with a first exemplary embodiment of the present disclosure.

FIG. 2 is an illustration of a human-guided system for performing inventory management and cleaning within a commercial facility, in accordance with the first exemplary embodiment of the present disclosure.

FIGS. 3A-3B are illustrations of a rideable system for performing inventory management and cleaning within a commercial facility, in accordance with the first exemplary embodiment of the present disclosure.

FIG. 4 is a flow chart showing an exemplary process for determining inventory information using the system of FIG. 1.

FIG. 5 is a flow chart showing an exemplary process for determining a confidence level for the inventory information using the system of FIG. 1

FIG. 6 is a block diagram of exemplary systems operating within and external to the system.

FIG. 7 is a plan view of the system of FIGS. 1-3B travelling through the facility.

FIG. 8 is a flow chart for a method of inventorying a commercial facility while cleaning the floor of the commercial facility.

### DETAILED DESCRIPTION

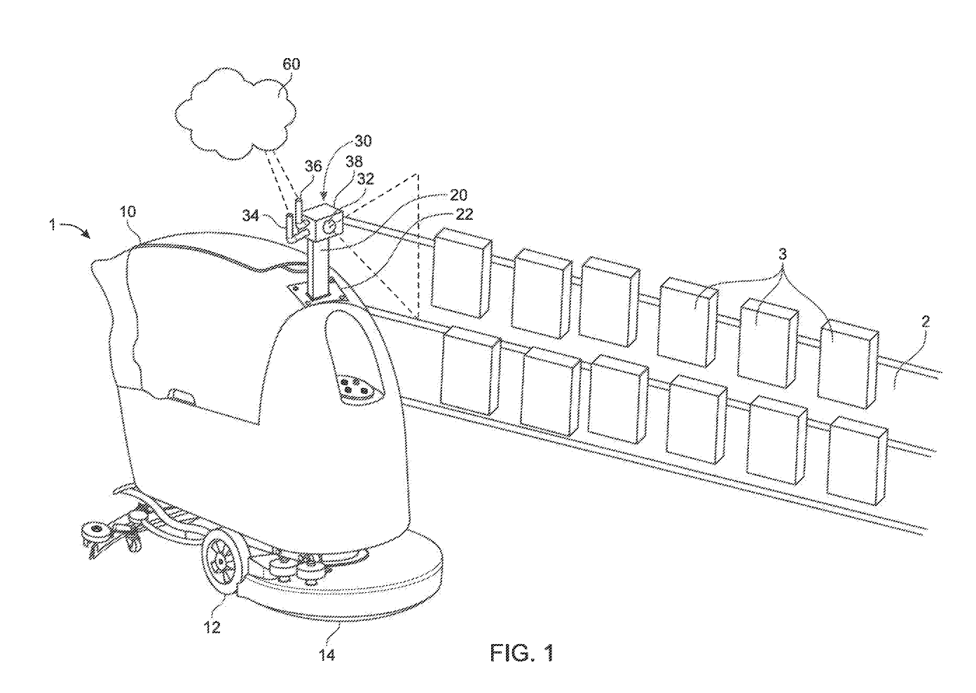

FIG. 1 is an illustration of a system 1 for performing inventory management and cleaning within a commercial facility, in accordance with a first exemplary embodiment of the present disclosure. The system 1 includes a mobile cleaning vehicle 10 configured to clean a floor of the commercial facility, at least one imaging sensor 32, a transmitter 34 for sending inventory information to a database 60, and a receiver 36 for receiving inventory information from a database 60. A computer 38 is in communication with the mobile cleaning vehicle 10, at least one imaging sensor 32, transmitter 34, and receiver 36. The computer 38 is configured to: capture inventory images from the at least one imaging sensor 32, detect inventory by comparing captured inventory images with stored inventory images, determine inventory information, determine a confidence level for the inventory information, and communicate at least a portion of the inventory information to the database 60. A platform 20 is mountably connected to the mobile cleaning vehicle 10 and supports the at least one imaging sensor 32, transmitter 34, receiver 36, and computer 38 on the mobile cleaning vehicle 10.

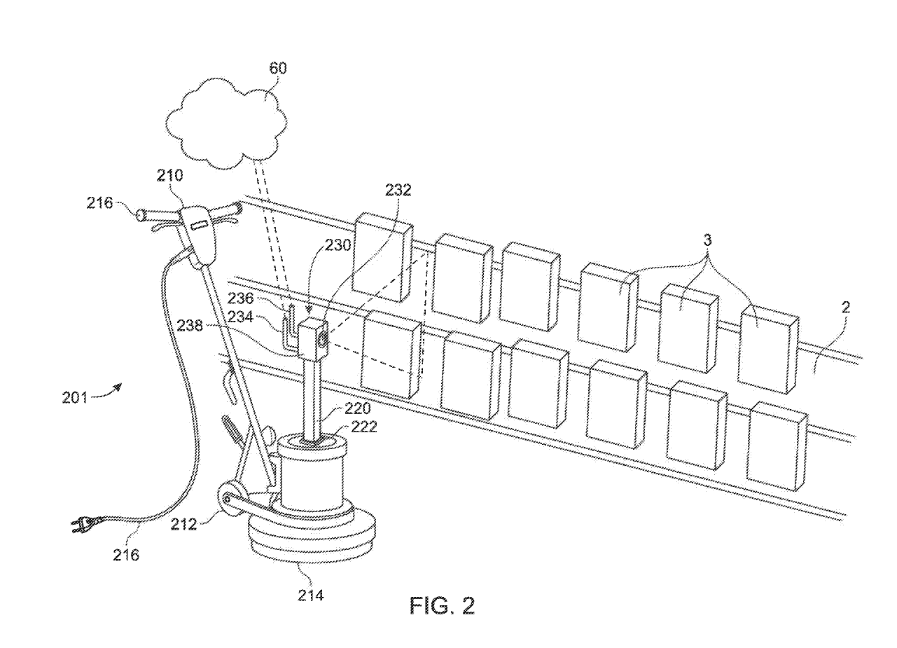

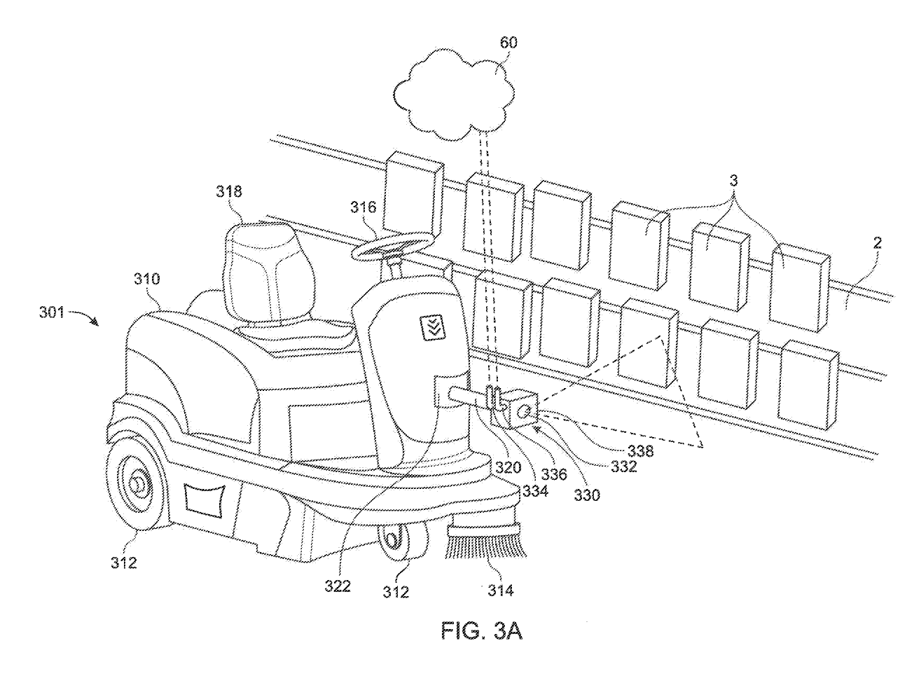

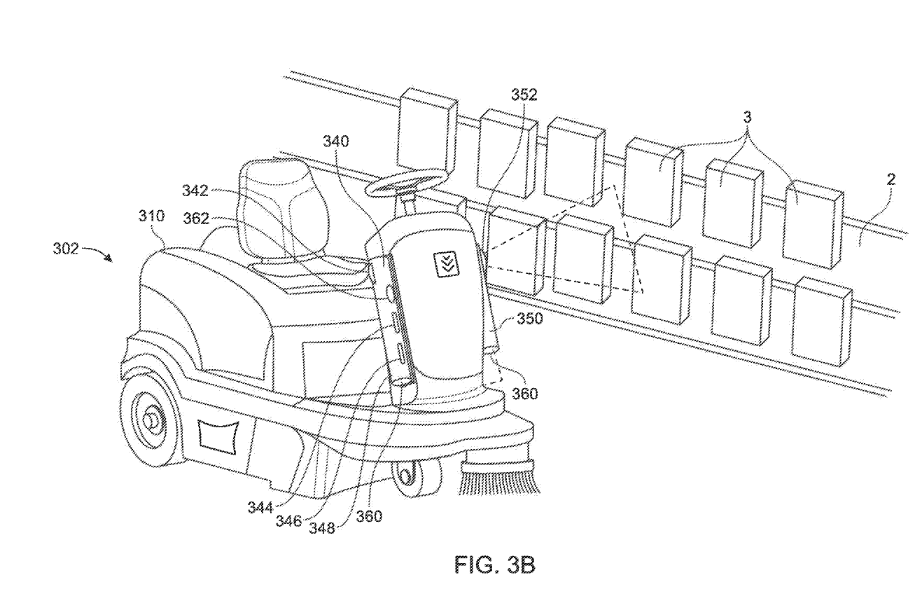

The mobile cleaning vehicle 10 may be any electronically powered cleaning device used to clean floors. FIG. 1 shows a semi-autonomous cleaning vehicle 10 having wheels 12 and a floor scrubbing system 14. The cleaning vehicle 10 may also be full autonomous. FIGS. 2-3B show other exemplary embodiments, discussed further below. The mobile cleaning vehicle 10 may be electrically powered, by connection to a wall outlet or by battery power. The mobile cleaning vehicle 10 may further include a power system. The power system may include a battery and a charging system. The battery may be a rechargeable lead-acid battery, lithium ion battery, or any other type of battery. The charging system may include an interface which allows the system 1 to electrically couple to a docking station (not shown) for charging. The power system may include power distribution circuitry and components, including regulators, heat dissipation devices, fuses and/or circuit breakers. Furthermore, the power system may include an emergency cut-off circuit which may automatically, or manually, cut power from the system 1 under certain circumstances, for example if the battery is too hot, if the battery is below a certain minimum threshold charge, or if the system 1 moves outside of a predefined area. Battery life may vary significantly depending on the operation of the system 1. In one example, the battery type, size and capacity may allow for a full day of use between charges. The mobile cleaning vehicle 10 and the other electronic components may share electrical power, and may be in electrical communication with one another. In one example, electrical power may be shared through a port on the mobile cleaning vehicle 10. In another example, electrical communication may be permanently established through the housing of the mobile cleaning vehicle 10. In another example, the other electronic components, namely the at least one imaging sensor 32, receiver 34, transmitter 36, and computer 38, may have a separate power source from the mobile cleaning vehicle 10.

The mobile cleaning vehicle 10 may move forward, backward, or to the side by use of its wheels 12 and a steering mechanism (not shown). The mobile cleaning vehicle 10 may be human-controlled, autonomous, or semi-autonomous. In the example shown in FIG. 1, the mobile cleaning vehicle 10 may be a semi-autonomous vehicle which is positioned by a human user and directed to autonomously clean a portion of the floor of the commercial facility. For example, a human user may position the mobile cleaning vehicle 10 at one end on an aisle, then engage the autonomous cleaning mode. The mobile cleaning vehicle 10 may autonomously clean the aisle from one end to another. The human user may then retain control of the mobile cleaning vehicle 10 and position it for further cleaning. The scrubber 14 may be any pad, brush, or bristles suitable for cleaning flooring. For example, the scrubber 14 may have rough bristles for sweeping or cleaning concrete and other exterior floors, for instance in the garden sections of hardware stores. The scrubber 14 may have a pad for cleaning and polishing glossy floors such as waxed tile and linoleum. The scrubber may have a combination of pads, brushes, and bristles as desired. The mobile cleaning vehicle 10 may perform any desired floor cleaning. This may include sweeping, vacuuming, wet carpet cleaning, mopping, drying, waxing, polishing, spill and hazard removal, or any combination thereof.

A platform 20 may be mountably connected to the mobile cleaning vehicle 10. The platform 20 may be connected at any suitable location to enable the system 1 to perform inventory management within the commercial facility. For example, FIG. 1 shows the platform 20 mounted to a substantially horizontal surface on the mobile cleaning vehicle 10 and rising up from the vehicle 10 in a vertical direction. This may allow the at least one imaging sensor 32 to be positioned at the right height to image all of the inventory 3 on a shelf 2. The platform 20 may be connected in any other suitable location on the mobile cleaning vehicle 10, for instance, on the front, on one or both sides, or at the rear. The shape, length, and height of the platform may depend on the size and speed of the mobile cleaning vehicle 10, the width of aisles, the height of shelves 2, and any additional factors. The platform may be mountably connected by a bracket 22, which may be affixed to the mobile cleaning vehicle 10 by any suitable means, including adhesive, epoxy, screws, bolts, welding, friction, or any combination thereof.

The platform 20 may support at least one imaging sensor 32, transmitter 34, receiver 36, and computer 38 on the mobile cleaning vehicle 10. The computer 38 is configured to capture inventory images from the at least one imaging sensor 32, detect inventory by comparing captured inventory images with stored inventory images, determine inventory status, determine a confidence level for the inventory information, and communicate at least a portion of the inventory information to the database 60. The database 60 may be any wirelessly-connected database, including a cloud database, local database, or any combination thereof.

The computer 38 can be any computing device constructed from various hardware and software components utilizing any known operating system. In one embodiment, the computer 38 is a mini computer that uses Ubuntu operating system and includes a single 12V power supply. The computer 38 may have sufficient processing power to run a variety of software, including for example, an Operating System (OS), video processing with OpenCV, and the like. Any computing components known in the art may be used with the computer 38.

The computer 38 may have one or more processors and associated circuitry for the control and imaging of the system 1. The processor may be, for example, an Arduino Mega microcontroller, which allows for easy development along with serial output, and may act as a serial (e.g., via USB) device that provides an interface to the computer 38. The processor may be any processor, microprocessor or microcontroller, and may be a PIC microcontroller, which is generally powerful and allows for high speed USB and Ethernet connections for data transfer. The processor may include or be associated with some amount of computer-readable memory, including RAM, cache memory, hard drives (HDDs), and solid state drives (SSDs).

The system 1 may include a transmitter 34 and a receiver 36 for sending and receiving information from the database, human operators, or other computer systems. The transmitter 34 and receiver 36 may be any type of communication hardware used for communicating over wireless protocols, for instance, Wi-Fi®, Bluetooth®, NFC®, cellular communications protocols, or any other network arrangement and/or protocol known to those having ordinary skill in the art. In one example, the system 1 may use a combination of wireless protocols to communicate.

The system 1 may further include a location detector. The location detector may utilize any of a number of known location detection techniques, including Global Positioning System (GPS), Indoor Positioning System (IPS) and Inertial Navigation System (INS), to detect the location of the system 1. The location detector may also function in coordination with any number of maps, floorplans, or similar schematics of a layout of the facility in which the system 1 is utilized.

The at least one imaging sensor 32 may be located anywhere on the platform 20 beneficial for capturing images of inventory. In one example, the imaging sensor 32 may be positioned so that it is substantially parallel to items within the field of view while the system 1 travels along a route. The system 1 may be equipped with additional imaging sensors. The system 1 may also be equipped with environmental or hazard sensors (hereinafter “other sensors”). The imaging sensor 32, additional imaging sensors, and other sensors are discussed in greater detail below.

The computer 38, transmitter 34, receiver 36, and at least one image sensor 32 may be located in a housing 30 that stores and protects these components. The housing 30 may be any shape and size suitable for keeping these components. The housing 30 may be located on the platform 20.

As the system 1 travels and cleans within the commercial facility, it may perform the process of capturing inventory images using the imaging sensor 32. Depending on the design, in implementation, the imaging sensor 32 may be a camera or camera system. For example, the system 1 may be equipped with a digital camera that captures the visible, infrared, ultraviolet, radio spectrum, or a combination thereof. In another example, the system 1 may be equipped with additional imaging sensors such as sonar, LIDAR, radar or other object detection systems. Multiple systems may work together to detect objects within the store. For instance, a visible spectrum camera system may be used to capture images of store inventory, while an infrared camera system may detect persons or obstacles in the path of the system 1. In another example, the visible spectrum camera system may capture images of store inventory, and a lower-resolution visible spectrum camera system may detect persons or obstacles in the path of the system 1.

In one example, the system 1 may use a visible spectrum camera (hereinafter, a “camera”) to capture images of inventory along a route between waypoints. The camera may be fixed on the system 1 at a particular height and orientation. This height and orientation may be determined by aisle size, product size, inventory location, lighting conditions, or other factors. The camera may also be movably attached to the system 1 and may move up or down, forwards or backwards, side to side, or rotationally as it captures images. In one example, the camera may be capable of optical telephoto or digital zoom. The system 1 may be programmed to adjust the position, angle, and zoom of the camera based on the system 1's location or expected inventory capture.

The camera may have adjustable exposure settings, such as aperture, shutter speed, ISO, white balance, exposure compensation, gain, capture rate, gamma, and exposure bracketing. This may allow the camera to operate under a variety of lighting conditions, working distances, capture rates, and travel speeds. In one example, the exposure settings may be adjusted in software by the system 1. Exposure settings may be fixed after being initially set, or they may be adjusted from time to time. In one example, the system 1 may adjust the exposure settings before each image capture based on the conditions mentioned above. In another example, the system 1 may adjust the exposure settings based on the inventory to be photographed and the detail or resolution necessary to accurately detect a label or barcode. In yet another example, a human operator may intervene to control some or all of the exposure settings for an image or area, particularly if one or more of the images is not being properly exposed.

In one example, the camera may have a software autofocus feature. The autofocus may operate in conjunction with the label detection software to determine the location of a label within the field of view before the image is captured. The camera may then focus on that portion of the field when capturing the image. For example, if the system 1 is attempting to capture an image of a particular product, it may take one or more photos of the area where it believes the product to be located. The system 1 may run label detection software to detect the presence of product labels within the photos. The system 1 may then capture another image, adjusting the focus to the areas where labels were detected. In this way, the labels will be in focus for image processing and analysis.

The optical components of the camera may be adjusted based on characteristics of the facility or the inventory. For instance, the camera may utilize different lenses in different facilities, such as a wide angle lens where store aisles are narrow and a large focal length lens where store aisles are wider. The field of view of the camera may vary depending on the camera and lens configuration used. The camera may also operate with lens filters, such as polarizers, ultraviolet filters, and neutral density filters, as are commonly used in photography.

The camera may also utilize an onboard flash to provide key or fill lighting when necessary. The system 1 may determine when to use flash automatically based on the environmental conditions and image capture requirements. For instance, the system may detect the ambient lighting in the part of the facility where the image is being captured and determine if flash would improve the image exposure. If that part of the facility is bright, such as during midday or when overhead lighting is on, the camera may use little or no flash. If that part of the facility is dimly lit or dark, such as during the evening or when overhead lighting is off the camera may use more flash. If a part of the facility is bright, but a portion of the item to be photographed is in shadow, the camera may apply some flash to bring out detail in the shadowed area. Individual waypoints may have custom flash settings that may be determined by the time of day, the system 1's location within the facility, or the amount of detail resolution needed from a particular image. For example, images requiring very high detail resolution may require neutral exposure in much of the image area. The camera may provide flash for a portion of the image, or for multiple portions of the image area. As another example, a waypoint in the back corner of the facility may always receive flash, but the waypoint immediately next to it may not. As yet another example, a particular waypoint may always receive flash when the system 1 captures an image at the end of the day, but it may not receive flash during other times of capture. The flash may be direct light, diffuse light, or some combination thereof. The system 1 may determine when to use direct or diffuse flash lighting based on the waypoint, the time of day, the type of item, or other factors. In addition to compensating for ambient lighting, the system 1 may provide flash to compensate for other lighting factors such as excess glare, seasonal display lighting, directional or diffuse sunlight, or reflective surfaces. For example, if a seasonal display places items in a location that receives less ambient light than usual, the system 1 may detect this and add flash when capturing an image. Or, if sunlight unevenly lights an item or area, the system 1 may add flash to even the exposure.

As another example, if the item to be photographed has a shiny or reflective surface, such as glass, plastic, or foil, the addition of flash may cause the item to be overexposed in the image. In such a case, the system 1 may employ an off-axis flash or diffuse lighting element, in combination with filters and other hardware, to properly expose the item. Alternatively, the system 1 may capture an image using normal flash and analyze the image for overexposure from shiny or reflective surfaces. If the system 1 detects overexposure, it may take additional images at different angles and distances in order to minimize glare. Additionally, the system 1 may be able to determine the type and number of reflective items based on their reflective characteristics. For example, the system 1 may learn that a certain type of item creates strong reflections in the area where it is located. The system may capture images, with and without flash, and analyze the reflections for characteristics of that item. As another example, the system 1 may capture an image without flash to identify the type of a reflective item, then capture other images with flash to identify the number of those items. The computer 38 may analyze the images with flash to easily count the number of reflective surfaces.

As another example, if the system 1 is travelling at high velocity, it may require flash to properly expose the image. At a high travel velocity, the shutter speed of the camera must increase to prevent motion blur on the imaging sensor 32, and increased shutter speed means that the imaging sensor 32 captures less light when making the image. Therefore, the system 1 may use flash to brighten the image properly.

A flash may also be used to provide backlighting for the image. For example, when the system 1 attempts to determine whether an item is out of stock, it may analyze the middle ground or background of the image for clues that items are missing. If a portion of the shelf is visible, or if no item details are detected, the computer 38 may determine that the item is out of stock. Backlighting may help to properly expose for these areas in the image.

Additionally, the system 1 may employ a shade on occasion to block or diffuse harsh direct lighting. For example, where ambient or overhead lighting casts uneven shadows over an item to be photographed, it may be difficult for the computer 38 to process the image. The system 1 may place a shade between the light source and the item in order to even the exposure on the item.

The system 1 may capture images at several points throughout the facility. Depending on the design, in implementation the system 1 may capture images of one type of item at a time. In another example, the system 1 may capture images of multiple types of items at a time. The subject matter captured in an image may be determined by the system 1 based on item characteristics such as item or label size, field of view of the camera, or other factors. The system 1 may capture several images in rapid succession for image stacking or superresolution processing. In image stacking, multiple images captured from the same location may be overlaid and blended to bring out details in the final image. Each successive image may have different exposure settings or focus points. The final, composite image may have a higher dynamic range or a wider depth of focus than any of the individual images, allowing the system 1 to better detect subject inventory in the image. In superresolution, multiple images captured as the image sensor moves or is moved slightly, creating subpixel shifts in the intensity of light captured in each image. The combined images can be used to resolve details of finer resolution than in any one image. After capture, the images may be stored in memory onboard the system 1. The system 1 may automatically determine when to capture multiple images and apply image stacking or superresolution techniques during image processing.

FIG. 2 is an illustration of a human-guided system 201 for performing inventory management and cleaning within a commercial facility, in accordance with the first exemplary embodiment of the present disclosure. The human-guided system 201 may include the same components discussed above relative to FIG. 1, including a mobile cleaning vehicle 210, platform 220, at least one imaging sensor 232, transmitter 234, receiver 236, and computer 238.

The mobile cleaning vehicle 210 shown in FIG. 2 is human-guided, meaning that a human user directly controls the motion of the mobile cleaning vehicle 210. In the example shown, a human user may control the mobile cleaning vehicle 210 by using handles 216 located thereon. The mobile cleaning vehicle 210 may have wheels 212 for transporting between cleaning locations, a scrubber 214 for cleaning the floor of the commercial facility, and an electrical power source 216.

A platform 220 may be mountably connected to the mobile cleaning vehicle 210 at any suitable location on the vehicle. In the example shown, the platform 220 is connected to a substantially horizontal surface on top of the mobile cleaning vehicle 210 by a mounting bracket 222, which may be affixed by any suitable means.

The electronic components, including the at least one imaging sensor 232, transmitter 234, receiver 236, and computer 238 may be supported by the platform 220 and may be located within a housing 230 supported by the platform 220.

FIGS. 3A-3B are illustrations of rideable systems 301, 302 for performing inventory management and cleaning within a commercial facility, in accordance with the first exemplary embodiment of the present disclosure.

In FIG. 3A, the system 301 includes a rideable mobile cleaning vehicle 310 with a steering wheel 316 and seat 318 for a human operator. The mobile cleaning vehicle 310 may also include wheels 312 and a scrubber 314. The wheels 312 may allow the mobile cleaning vehicle 310 to drive around the commercial facility, while the scrubber 314 may allow the mobile cleaning vehicle to clean the floor. A human user may operate the mobile cleaning vehicle 310 by sitting in the seat 318 and manipulating the steering wheel 316. The mobile cleaning vehicle 310 may include a power supply, such as a battery, and additional cleaning supplies such as detergent, dust catchers, filters, vacuum systems, and the like.

A platform 320 is mountably connected to the mobile cleaning vehicle 310. The platform 320 may be connected by a mounting bracket 322. In FIG. 3A, the platform 320 is shown extending horizontally from the front of the mobile cleaning vehicle 310, and is mounted to a substantially vertical surface on the mobile cleaning vehicle 310. In another example, the platform 320 may be mounted at any suitable location on the mobile cleaning vehicle 310. The platform 320 may support the at least one imaging sensor 332, transmitter 334, receiver 336, and computer 338. These components may be located within a housing 330 connected to the platform.

FIG. 3B shows a system 302 including a rideable mobile cleaning vehicle 310. The system 302 includes two platforms 340, 350 mounted at either side of the mobile cleaning vehicle 310. The platforms 340, 350 may be mounted to substantially vertically surfaces on the mobile cleaning vehicle 310, and may support at least one imaging sensor 342, 352, transmitter 344, receiver 346, and computer 348. In one example, the platforms 340, 350 may support additional components, such as floor sensors 360, environment sensors 362, and other sensors. Floor sensors 360 may scan the floor of the commercial facility to determine if there is dirt, refuse, or other material to be cleaned. The floor sensors 360 may determine the presence and type of material, and may communicate this to the computer 348, which may report this to the human user. Environment sensors 362 may scan the area ahead of the mobile cleaning vehicle 310 for pedestrians or obstacles that must be avoided. When pedestrians or obstacles are detected, the environment sensors 362 may communicate this to the computer 348, which may issue a warning to the human operator, cause the vehicle 310 to slow down, or engage avoidance procedures. Other sensors may include additional imaging sensors, for example, to increase resolution or field of view, or sensors for imaging different parts of the spectrum.

In the implementation shown in FIG. 3B, the system 302 may perform inventory imaging on both sides of an aisle at the same time. Imaging in multiple directions is not limited to this particular implementation; the implementations shown in FIGS. 1-3A may also include imaging sensors for imaging in two or more directions. In these implementations, imaging sensors may be oriented so that their fields of view encompass the desired number of directions. For example, a 2-directional imaging systems may include imaging sensors oriented between 90° and 180° in order to image items 3 on opposing shelves 2 in an aisle or walkway.

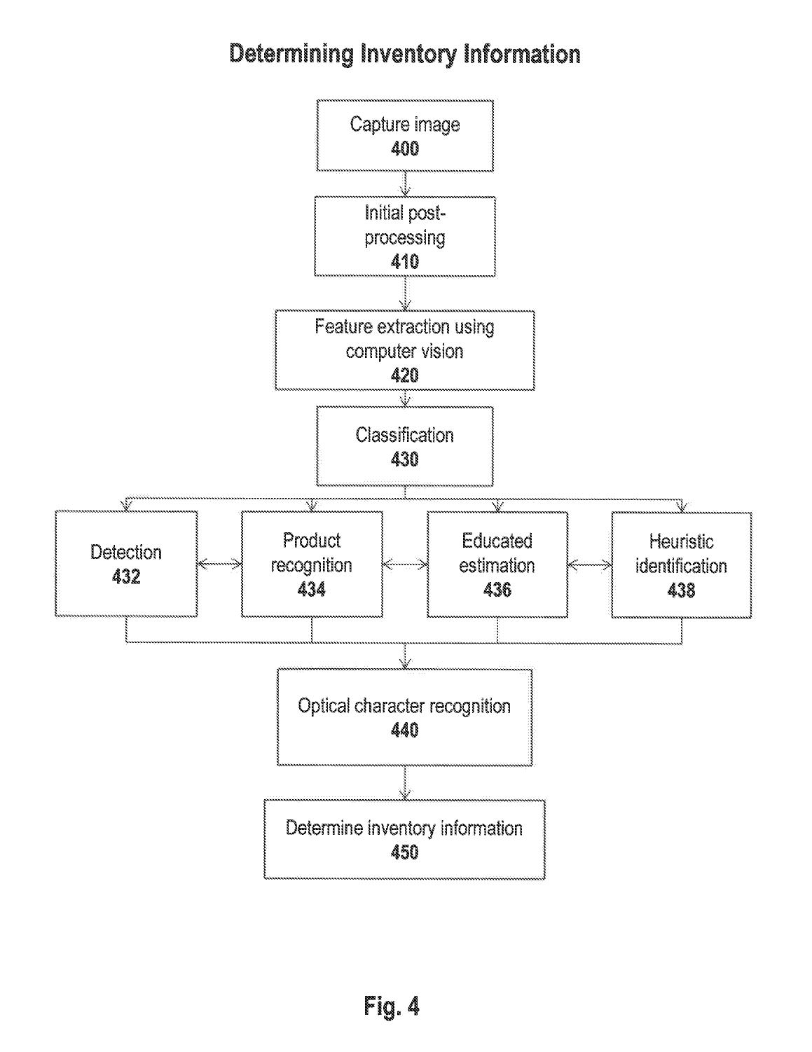

FIG. 4 is a flow chart showing an exemplary process for determining inventory information using the system of FIG. 1. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

Relative to FIGS. 1-4, once an image has been captured as shown in box 400, it may be processed using initial post-processing, computer vision, neural network, machine learning, or deep learning techniques. For instance, important features may be extracted from the image using computer vision. The computer 38 may then apply neural network, machine learning or deep learning techniques to process the extracted features. The computer 38 can use this processed information to detect the location of items, labels, and barcodes.

Generally, this kind of image processing uses an image data set to train the computer 38 to detect stock items. The computer 38 may be given images showing the items, the labels, the items in stock, the items out of stock, and similar variations. The computer 38 may use these images to learn the characteristic qualities of the item or the level of stock. With each subsequent viewing, the computer 38 learns more about the characteristic qualities.

Image processing may be based on a number of approaches used alone or in concert. For instance, as shown in box 410, image processing may begin with initial post-processing techniques such as adjusting exposure, white balance, highlights, shadows, image rotation, or cropping. These techniques may make the image easier for the computer 38 to process further. As shown in box 420, the computer 38 may extract features from the image using computer vision techniques. Extracted features may further prepare the image for processing.

The computer vision techniques may be particularly useful in performing label extraction of products, barcode detection and extraction of products, determining if an item is out of stock or in stock, and with providing a street view of an indoor environment. Relative to label extraction, the system 1 may utilize color thresholding and contour detection to determine the location of the labels of products containing the label information. The extracted labels are then used for barcode detection. Barcode detection may utilize a gradient magnitude of the image (label) in horizontal and vertical directions, which can be determined using one or more imaging processing operators. For example, Scharr operators, which result from an optimization minimizing a weighted mean squared angular error in the Fourier domain, may be used to detect barcode edges. The region with high horizontal gradients and low vertical gradients may be identified. High frequency noise may be smoothed from the gradient image. Blurred images may be subject to thresholding and morphological operators are applied on the thresholded image. Using contour detection, the barcode region from a label is extracted, which permits identification of the item information, a price, a location of the item, and a window size for searching for the item in an image.

As shown in box 430, a classification approach may be used to assist in label or barcode detection. The classification approach uses labels and barcodes cropped from raw images to build classifiers that help the software recognize items. Classifiers may be managed at different hierarchical levels to detect stock and recognize products. For instance, classifier levels may include, but are not limited to: data from all stores, data from a single store, data from a single department across all stores, data in a single department in a single store, data for a particular product category across all stores, and data for a particular product category in a single store. After the classifiers are built, they may be improved using captured image data or data from previous results.

Boxes 432, 434, 436, and 438 show other approaches that may be used, in detecting inventory and determining inventory information. As shown in box 432, detection approach may be used to identify whether any items are out of stock by considering, without looking at every item in the image, whether there appear to be any items out of stock. The detection approach uses the entire image to train a classifier which determines the location of an item and whether any stock is missing. As shown in box 434, a product recognition approach may use data extracted from labels or barcodes to create product categories. Product categories can assist in building classifiers using neural network, machine learning, or deep learning techniques. As shown in box 436, an educated estimation approach may compare images from previous captures to determine how much stock remains. As shown in box 438, a heuristic identification process may be used to identify an item by its price label. The heuristic process compares previous images captured under similar conditions, such as location in the store or distance from the item, to new images, comparing detected features and other data.

As shown in box 440, the system 1 may use optical character recognition algorithms to extract text from labels. Once a label has been detected, the computer 38 may run optical character recognition algorithms to extract product names, SKU numbers, barcodes, prices, and the like. The computer 38 may determine a confidence level for any information extracted using these algorithms. If the computer 38 is not able to extract the optical character recognition information with enough confidence, it may upload a high resolution image to the database 60 for further optical character recognition processing. The computer 38 may use partial information or information from more than one category to determine the type or number of items.

It is noted that the processes described herein may be used with multiple images compiled together, so-called “image stitching”. Image stitching may be implemented to account for the regions of an image that are close to the borders of the image, in order to increase the usable area of an image. For instance, if an item or label is located between the opposite borders of two consecutive images, for instance, between the left border of one image and the right border of the next image, the computer 38 may stitch the images together and extract the inventory information from the combined image.

As shown in box 450, these processes can be used to determine inventory information. Using the locations of detected labels or barcodes, the computer 38 may determine where items are located on a shelf or in an aisle. Additionally, the computer 38 may use the locations of detected labels or barcodes to determine stock status, i.e., whether an item is in stock, low on stock, or out of stock. For example, to determine which items are in-stock or out-of-stock, a morphological operator may be applied to the structure background. Commonly, aisles in retail stores are classified into three different categories: pegs, shelves, and trays. Considering peg items, for example, if an item is out of stock, the computer 38 may have detected circles in the aisle backing. Around the label, the circle density within a given area may then be determined. If the circle density is high, the computer 38 may determine that the item is low stock or out of stock.

In another example, the system 1 can determine stock quantity data using additional imaging sensors 22, such as radar, sonar, or LIDAR sensors in combination with computer 38 vision techniques. This may be useful in helping the computer 38 identify items with changing packaging or appearance. In one example using radar, the system 1 may emit radio waves using a transmitter as it travels between waypoints. A radar sensor may detect reflected radio waves, and the computer 38 may process the detected data to determine the number of items in stock or on display. The radar sensor may be a millimeter-wave sensor (MMW) capable of detecting electromagnetic radiation in the extremely high frequency (EHF) band, between 30-300 GHz. MMW sensors may detect items at a distance of up to several meters and within a resolution of a few centimeters. For instance, an integrated transmitter/receiver MMW chip, such as the Texas Instruments@ IWR1443, which operates between 76-81 GHz, may be used to detect and resolve items just a few centimeters apart on a shelf. MMW sensors may be used at high travel velocity and without ambient lighting. In another example, data from the radar sensor may be used in combination with captured images to accurately determine stock quantity data. For instance, the system 1 may transmit and detect radio waves at about the same time the camera is capturing images of a product area. The computer 38 may process both sets of data together. The radar data may first be processed using computer 38 vision techniques to determine an estimated number of items on display. The captured image data may then be processed to detect and extract labels or barcodes. This inventory information may be cross-referenced with determinations made using the radar data to accurately determine stock quantity. These steps may be performed in any combination, order, or recursion necessary to determine stock quantity and other inventory information. This may be especially useful for products of small size and shape, for example, screws and other small hardware components. The computer 38 may also use machine learning, deep learning, and neural network approaches to learn how to process this data together. In another example, data received from sonar or LIDAR sensors may be processed alone or with captured images in a similar manner. The system 1 may have multiple radar, sonar, or LIDAR sensors, or any combination thereof. The system 1 may determine when to use one or more of the sensors alone or in combination with the image sensor based on environmental conditions, product or label size, speed of travel, or other factors. For instance, a system 1 operating in a low light environment may use two or more sensors to capture item data to increase the information available for processing. Or a system 1 traveling at a high velocity may use two or more sensors to capture item data in order to overcome blurry or underexposed captured image data.

In yet another example, the system 1 may use multiple sensors in sequence to improve captured data. For instance, the system 1 may be equipped with radar and image sensors, with the radar sensor placed ahead of the image sensor in the system 1's direction of travel. The radar sensor may capture preliminary data that the computer 38 may process to indicate the quantity of items on display. The system 1 may use this information to adjust the camera settings, such as exposure, aperture, or number of images taken, to properly capture all of the items on display. This process may be done with any combination and number of sensors.

The system 1 may perform image capture and processing even when it is not connected to the internet. Images and results may be saved to the system's memory and uploaded once a connection has been restored.

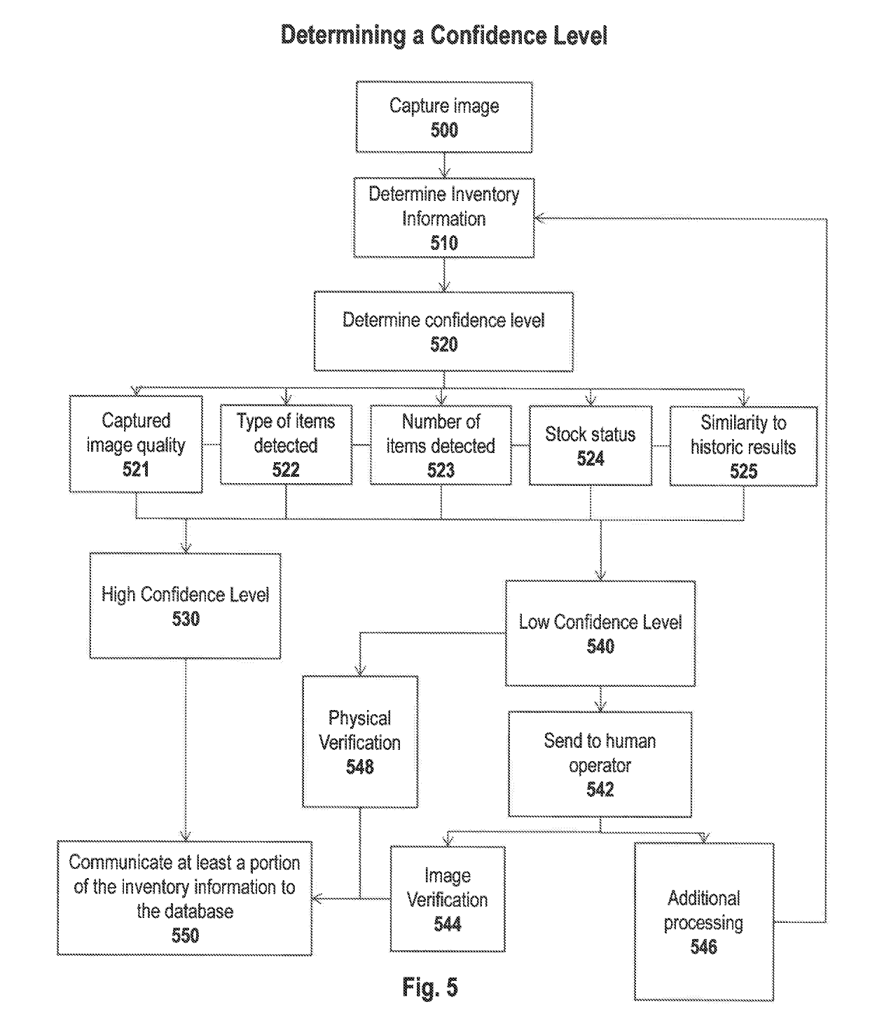

FIG. 5 is a flow chart showing an exemplary process for determining a confidence level for the inventory information using the system of FIG. 1. After capturing an image, as shown in box 500, and determining inventory information, as shown in box 510, the computer 38 may determine a confidence level for the inventory information, as shown in box 520. The confidence level may be determined by a number of factors, as shown in boxes 521-525, including captured image quality, the type of items detected, the number of items detected, the stock status of the items, similarity to historic results, respectively. Other factors known to those of skill in the art may be considered. In one example, the computer 38 may assign a higher confidence level for images taken in optimal lighting conditions or clearly showing a label or a barcode. The computer 38 may assign a lower confidence level for images with low contrast, or where a label or barcode is obscured. Similarly, the computer 38 may assign a higher confidence level for images where the type and number of products can be accurately determined, while assigning a lower confidence level where the computer 38 cannot make a determination. Further, the computer 38 may assign a higher confidence level where the determined inventory information is similar to historically determined inventory information, but assign a lower confidence level where the determined inventory information varies in a statistically significant way. In one example, the computer 38 may use some combination of these factors in determining the confidence level. Some factors may be considered more or less heavily, i.e., given weights, depending on the presence and extent of the factors.

As shown in box 530, inventory information with a confidence level above a threshold may be communicated to the database 60, as shown in box 550. This information may automatically be entered. This threshold may be the same for all items in a commercial facility, or it may differ from item to item. For example, an extremely high confidence level may be desired for expensive, high margin items, or items prone to theft. A lower confidence level may be acceptable for less expensive or low margin items, as there may be too great a trade-off between accuracy and the effort required for accuracy. Threshold confidence levels may be determined by the system 1, the database 60, facility owners, or other software. Threshold confidence levels may be changed on occasion, for example, seasonally.

As shown in box 540, inventory information with a confidence level below a threshold may not be automatically entered by the database. In box 542, inventory information with a confidence level below a threshold may be sent to a human operator for additional analysis or confirmation of results. The human operator may use the image to manually determine inventory type, label, amount, or stock status, as shown in box 544. The human operator may then direct the database to enter the inventory information, as shown in box 550. Alternatively, as shown in box 546, the human operator may send the inventory information back to the system 1 for additional processing and further communication to the inventory database 60. In one example, inventory information with a confidence level below a threshold may direct the system 1 to capture additional images for the subject inventory. The system 1 may return to the portion of the facility where the image was taken and take another image. The subsequent image may be processed and compared with the original image for confirmation of results. As shown in box 548, inventory information with a confidence level below a threshold may also direct the system 1 to ask a human employee in the facility to physically verify the results within the facility. The employee may check the inventory status and report it to the database 60, which may compare the inventory status with the original inventory information and submit that to the database.

When detecting inventory details such as labels or barcodes, the system 1 may use high resolution images for feature extraction. These images may have large file sizes, and a typical retail store environment may not have sufficient internet bandwidth to upload the images in or close to real-time. To circumvent this issue, the computer 38 may perform a portion of the image processing onboard. After the computer 38 has finished the image processing necessary to detect and identify, it may upload portions of images to the cloud for further processing or for validation by a human operator. For example, the system 1 may capture an image of an item and run its processing software onboard. After the item has been identified by its label, the computer 38 may crop the label from the image. The label may be uploaded at full resolution, while the original image may be uploaded at a lower resolution for later display or other analysis. As another example, after an item has been identified by its barcode, the computer 38 may crop the barcode from the image. The barcode may be uploaded at full resolution, while the original image may be uploaded at a lower resolution for later display or other analysis. As another example, when the computer 38 is attempting to detect the amount of stock on display, it may analyze the entire high resolution image in an effort to reach a decision above a threshold confidence level. If it can make a determination above the threshold confidence level, the computer 38 may upload a low resolution image, or no image at all. If it cannot make a determination above the threshold confidence level, the computer 38 may upload all or part of the high resolution image.

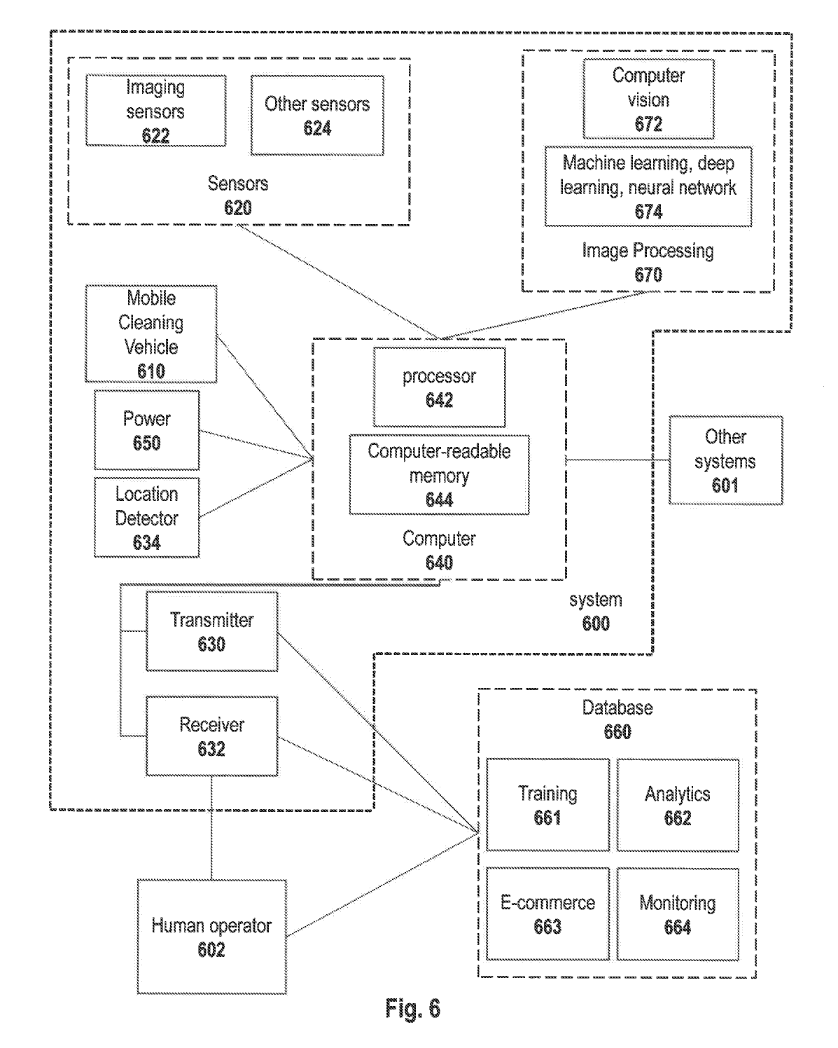

FIG. 6 is a block diagram of exemplary systems operating within and external to the system 600.

Block 600 shows the system and all of the hardware and software systems within. Block 601 shows that the system 1 may operate in conjunction and communicate with other systems. Block 602 shows a human operator that may be contacted by the system 600 or the database 660.

Additional hardware systems are shown in blocks 610, 650, 634, 630, and 632. Block 610 shows the mobile cleaning vehicle system, which may communicate with and control autonomous mobile cleaning vehicles. Block 650 shows the power system. Block 634 shows the location detector system. Blocks 630 and 632 show the transmitter and receiver systems, respectively.

Block 640 shows the computer system having a processor 642 and computer-readable memory 644.

Block 620 shows the sensors system having image sensors 622 and other sensors 624. The other sensors 624 may be temperature sensors, smoke detectors, carbon monoxide monitors, and the like. The system 600 may use these other sensors 624 to passively monitor for fire, carbon monoxide gas, or other environmental conditions adverse to inventory and humans. If adverse conditions are detected, the system 600 may send an alert to a human operator for further action. The system 600 may capture images of the affected areas and send them to the human operator for additional confirmation of the adverse conditions. The images may be sent to the database and marked to indicate potential problem areas or areas where items may be damaged.

Block 660 shows the database system. The database system 660 may have, as an example, training 661, analytics 662, and e-commerce 663 subsystems, among others.

The training system 661 may help the computer 640 to learn to recognize inventory items, labels, barcodes, and stock status in a number of ways. Training may be accomplished using images stored on the computer 640, on the database 660, or shared from the database to the computer 640. The computer 640 may initially learn inventory characteristics by applying machine learning techniques to a set of training images designed to teach the computer 640. The training images may show generic labels, barcodes, or other inventory characteristics, and the computer 640 may learn to recognize the characteristics based on relationships between like images. The training images may be customized to show inventory characteristics for a particular commercial facility. This may help the computer 640 learn more efficiently. Initially, the computer 640 may learn to identify the labels and barcodes of an item by corroborating with a price tag located on the shelf underneath or nearby the item. Price tags on shelves may be relatively static, and therefore, easier to identify with image processing. The computer 640 may attempt to detect an item's label or barcode, detect the item's price tag, and compare both results to determine a higher confidence level. After some time, the computer 640 may be sufficiently confident with the results of the label or barcode detection that it does not confirm with the price tag detection.

Additionally, the computer 640 may learn inventory characteristics from an initial image set processed with mechanical turk, i.e., using human intelligence to process images while the computer 640 discovers relationships between the processed images. After some time, the computer 640 may recognize inventory items, labels, barcodes, and stock status without the human contribution.

The computer 640 may also learn inventory characteristics from captured images taken during operation of the system 1. As the system 1 captures images and processes them to detect inventory, it may develop or refine the rules it uses to detect inventory characteristics. This may be done in real-time, as the system 1 is operating, or during idle time when the system 1 is charging or otherwise not in use. The system 1 may use captured images from other system is in the same facility or other facilities to learn inventory characteristics as well. The system 1 may be able to download images from the database to use in learning. To this end, the database may identify and make available images that are particularly helpful in system 1 learning.

The computer 640 may also learn inventory characteristics from captured images that resulted in confidence levels below a threshold. The computer 640 may use these captured images to understand why the confidence levels fell below the threshold, and develop rules for determining increasing confidence levels under those scenarios. The computer 640 may also use results obtained when it communicated those images to a human operator. The computer 640 may develop rules to understand why the human operator made a particular decision. In one example, the system 1 may use low confidence level images from other system Is to learn inventory characteristics as well. The system 1 may be able to download images from the database to use in learning. To this end, the database may identify and make available images that are particularly helpful in system 1 learning.

Classifiers and other types of rules may be improved using captured image data or using data which produced an incorrect result.

The analytics system 662 may provide detailed analysis of inventory information for human end users. By example, several types of analysis are discussed below.

Inventory information may be used in planogram analytics. For example, inventory information concerning the location and placement of items in the commercial facility may be compared to the location and placement of items dictated in a planogram. Users can use this comparison to ensure that items are placed in the proper locations in one facility. Other users may be able to monitor compliance with planograms across multiple facilities, for example, in franchise locations. Further, images and related data gathered by the system 600 may be useful in comparing different planogram layouts. In one example, a user may wish to compare the effectiveness of two or more different planogram layouts in multiple facilities. The facilities may stock their shelves or displays according to the planograms, the system 600 may capture, analyze, and communicate inventory information, and the database 660 may enter the inventory information from the facilities. The user may then use the information to compare sales, inventory turnover, product misplacement, or any combination thereof across the facilities. In another example, a user may wish to determine how multiple facilities unintentionally deviate from the prescribed planogram layout. The user may use the inventory information in the database 660 to quantify deviation across the facilities. In another example, the user may wish to correlate unintentional planogram deviation with sales or inventory turnover in a facility. In still another example, planograms may be software-optimized based on inventory information from the database 660 and sales goals for a facility. Planogram analysis may not be limited to one item or one area of the facility at a time. The database 660 may allow analysis of overall planogram compliance in one facility, or in multiple facilities. The database 660 may also allow analysis of planograms containing complementary or related items in different parts of the store. For example, the database 660 may allow a user to analyze how planogram compliance in the wine section and the cheese section is related to sales or inventory turnover.

Inventory information may be used to analyze stock data, such as the number of empty spots or out-of-stocks detected in an area or over a period of time. The analytics system 662 may analyze the percentage and number of discrepancies spotted in an area over time, the number of units of missing inventory, the number of out-of-stock events over a period of time, and opportunity costs because of products missing from a shelf. The analytics system 662 may also provide a heat-map of the facility showing where out-of-stocks occur over time.

The analytics system 662 may provide pricing analytics. For instance, inventory information can be used to provide real-time or near real-time analysis with competitors. In one example, software on the database 660 may pull stock and price information from competitors' websites. That information can be compared with the inventory information determined by the system 600 to provide a customer or store employee with accurate pricing and stock data. In another example, this comparison may allow stores to offer dynamic pricing based on the pricing and availability of similar items in a nearby geographic area. For instance, if the database 660 software determined that demand for a particular item was high, but availability in the area was low, it could communicate a suggested increased price to a user. Or, if availability was high and demand was low, it might communicate a suggested decrease price to a user. This dynamic pricing may be used within several stores under the same ownership to better price inventory based on demand and availability.

In another example, pricing analytics can be used to ensure correct pricing within a facility. The system 600 may be able to extract price information from the labels using optical character recognition, as discussed above. The computer 640 may then cross-check the extracted price information with price information contained within the database 660 or stored onboard to verify that the marked price of an item is the same as the intended price. If there is a discrepancy, the computer 640 may communicate it to the database 660 for further action by a human operator.

In still another example, the analytics system 662 may track and analyze a facility's responses to low inventory events, theft, and discrepancies. For instance, the analytics system 662 may track the number of low inventory events, the number of events resolved over time, the nature of resolutions, and the like. The analytics system 662 may also track employee information, such as which employees responded to events, response time, response effectiveness, and the like.

The analytics system 662 may also assist in tracking theft. When the computer 640 determines an area to have decreased inventory, employees may physically go to the area to confirm. In some cases, employees may simply restock according to a planogram. In other cases, the employee may be able to determine that one or more items have been stolen, such as when damaged packaging remains, but a product is missing. In those cases, the employee may be able to note the theft in the database 660. The system 600 may use this information in combination with machine learning or deep learning techniques to learn to detect theft automatically. To this end, the database 660 may identify and make available images of known theft for system 600 learning. In another example, the system 600 may adjust its route or waypoints to capture images more frequently in areas with known theft. The analytics system 662 may provide analysis of known theft, including times, locations, and item types, to allow facility owners to better protect this inventory.

The e-commerce system 663 may provide a platform for internet sales of items located within the facility. The database 660 may maintain inventory and location data for every item in a commercial facility, or across multiple facilities. E-commerce customers seeking to purchase items may interact with the database 660, which may search for in-stock items and provide location data to customers. In another example, once a customer places an order online, store associates may use the database 660 information to fill the order accurately and efficiently. For instance, a store software interface might communicate the customer's order to the associate, along with an optimal route for gathering items to fulfill the order. In still another example, the database 660 may display to the customer one or more of the captured images containing an item, allowing the customer to see the item, its packaging, and its location within a store. In still another example, the database 660 may actively communicate the stock status, price, regional availability, or other information about an item to a customer who is considering buying the item. This may allow the customer to decide to purchase when an item becomes available within a certain geographic region, or when the price within a geographic region has reached a desired level. This may also allow a customer shopping in one physical location to purchase from another physical location.

The monitoring system 664 may help human operators ensure that the system 600 is functioning properly. In one example, the database 660 may enter information useful for troubleshooting or calibrating the system 600. For instance, the database 660 may include information about waypoints where image data was and was not captured. This may help human operators determine why the system 600 was unsuccessful. As another example, the database 660 may include information about the percentage of an area that was successfully imaged or analyzed. This may help human operators determine where waypoints need to be adjusted or where environmental conditions need to be improved. The system 600 may send maintenance information, such as bug reports, test data, alerts, and notifications, to the database 660 or to human operators.

In another example, when multiple systems 600 are deployed within a facility to perform distributed imaging of the inventory, the monitoring system 664 may monitor the systems 600 to ensure proper coverage of the facility. For instance, the monitoring system 664 may analyze the location and capture time of images as the systems 600 upload them to the database 660. The monitoring system 664 may compare this information to expected routes and may direct one or more of the systems 600 to change routes. In another example, the monitoring system 664 may coordinate the deployment and return of systems 600 during peak business hours. In still another example, if one or more systems 600 sends inventory information with a low confidence level to the database 660, the monitoring system 664 may direct another system to capture another image to improve on or verify the results.

All of the database systems 661-664 may be accessed using a graphical interface through a software application or a website. The interface may work with a virtual model of the shelves and aisles in facility, such as a “master-shelf” model which maintains a virtual representation of all of the inventory information communicated to the database. The virtual model may not be a visual representation, but may be primarily a numerical representation of the inventory. The virtual model may be updated each time the system 600 communicates new inventory information to the database 660. Old inventory information may be maintained, averaged, or weighted with the new inventory information to provide a historical representation of the inventory information over time. Significant events, such as out of stock determinations, may cause the virtual model to be updated. The virtual model may use historic inventory information to form a general representation of a facility, i.e., a model of the way the facility is usually stocked and where items are usually located. The system 600 may use information from this general representation to detect low stock, stolen, or misplaced items by comparing a recently captured image with the general representation.

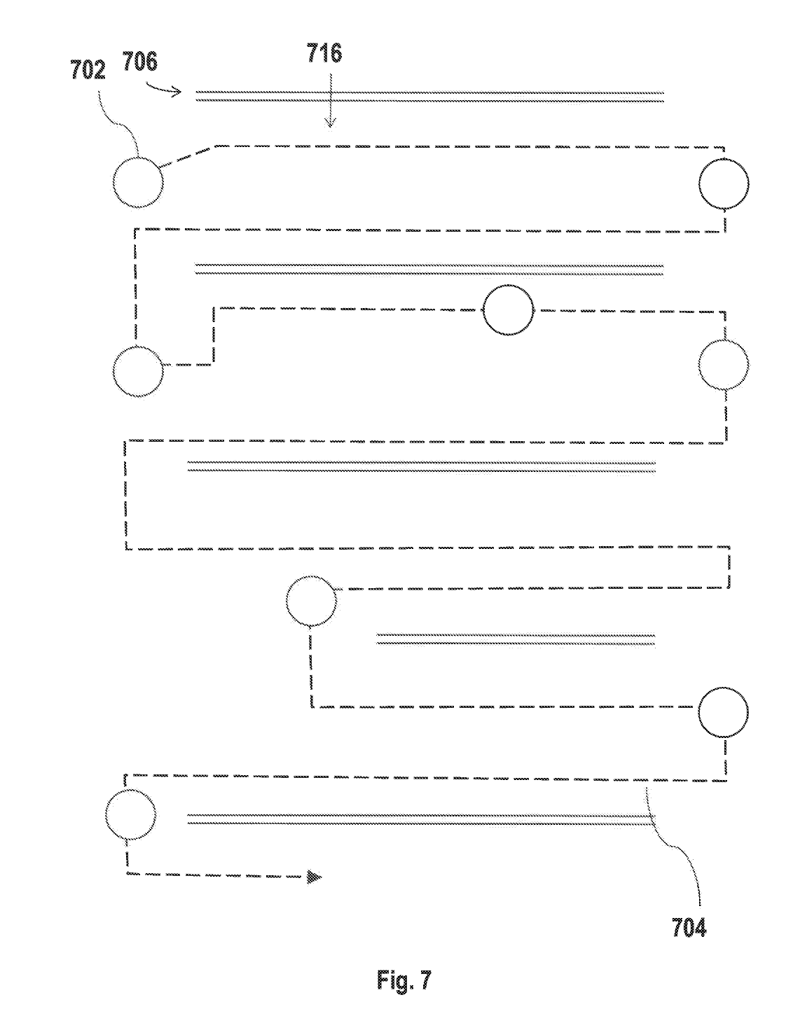

FIG. 7 is a plan view of the system of FIGS. 1-3B travelling through the facility. In one example, the system 1 may autonomously navigate through the store at any point in the day. For instance, the system 1 may first navigate through the store before it opens, to establish a baseline inventory analysis for the day while sweeping floors clean. It may navigate through the store and perform a cleaning regimen several times during business hours, concluding after the store closes. In another example, the system 1 may not be autonomous, but may be controlled by a human user. In this example, the human user may be directed to navigate the system 1 through particular waypoints 702 while cleaning in order for the system 1 to image the inventory completely.

The system 1 may be programmed to navigate through specific waypoints 702 in the store. Alternatively, the system 1 may determine its own waypoints 702. The system 1 may collect sensor data, such as images, at each waypoint 702, and may attempt to collect sensor data in precisely the same location in relation to each waypoint 702 as possible. The location of waypoints 702 may be determined based on time of day, number of people in the store, aisle size, item density, or other factors. Generally, waypoints 702 may at least be determined based on the system 1's field of view and the image size required to accurately identify inventory on shelves 706. In one example, waypoints 702 throughout the store may be calculated once and remain constant for a period of time. In another example, waypoints 702 may be recalculated periodically, such as each day or each week. Waypoints 702 may be determined, or changed ad hoc, by human operators temporarily as well.

The system 1 may navigate from one waypoint 702 to another. In one example, the system 1 may determine a route 704 that allows it to reach all of the waypoints 702 in the shortest amount of time. In another example, the system 1 may determine a route 704 that allows it to reach all of the waypoints 702 while traveling through substantially all of the aisles 716 in the facility. In other examples, the route 704 may vary to avoid customers in the facility, to capture images of certain areas more often, or to navigate through areas of high inventory turnover, among other reasons.

Waypoints 702 and routes 704 may also be determined based on a desired cleaning program. For instance, it may be desirable to clean the floor of the entire commercial facility once per day. Certain areas of the commercial facility may be open to cleaning during business hours, while certain areas may need to be cleaned after business hours. A route 704 may be determined based on which areas can be cleaned, and waypoints 702 may be established based on the route 704. In another example, a human user may determine the route 704 ad-hoc, and the system 1 may indicate potential waypoints 702 based on the currently-chosen route.

Waypoints 702 may also assist the system 1 in navigating. For example, the system 1 may confirm its location within the facility by comparing expected image data with actual image data at a waypoint 702. The system 1 may expect to capture images of a certain type of product at one waypoint 702, and it may compare the captured images to expected images. If the images are similar enough, the system 1 may confirm it is at the intended waypoint 702. Conversely, if the compared images are different enough, the system 1 may confirm it is at another waypoint 702 or is having trouble navigating.

Waypoints 702 may also assist the system 1 in label and barcode detection. For example, upon reaching a certain waypoint 702, the system 1 may expect to capture images of certain items within an aisle 716 associated with the waypoint 702. The system 1 may use this information to detect labels or barcodes more quickly by limiting its search parameters. In another example, the system 1 may know that items associated with a certain waypoint 702 are commonly misplaced, and may use this information to detect misplaced items more quickly.

Waypoint data may be included as part of the image metadata. For example, time and date of capture, location within the facility, and the system 1's distance from the product may be included as metadata. Metadata may be used in inventory analytics, discussed in greater detail below.

The system 1 may communicate waypoint data to a database or a human operator for analysis. For instance, the system 1 may communicate the waypoints 702 for which it was able to capture images, the percentage of the area around a waypoint 702 that has been imaged, or any issues in capturing images relative to a waypoint 702. If image capture issues arise, human operators can use the waypoint 702 data to pinpoint problems, guide the system 1, or route around a waypoint 702.

In one implementation, multiple systems 1 may be used in a facility. The system may work together to achieve distributed imaging of all inventory in the facility. For example, two systems 1 may travel down alternating aisles 716 capturing images until the entire facility has been scanned. In another example, multiple systems 1 may travel substantially exclusive routes, but may overlap in areas with high inventory turnover or known theft. The multiple systems 1 may be in communication with one another.

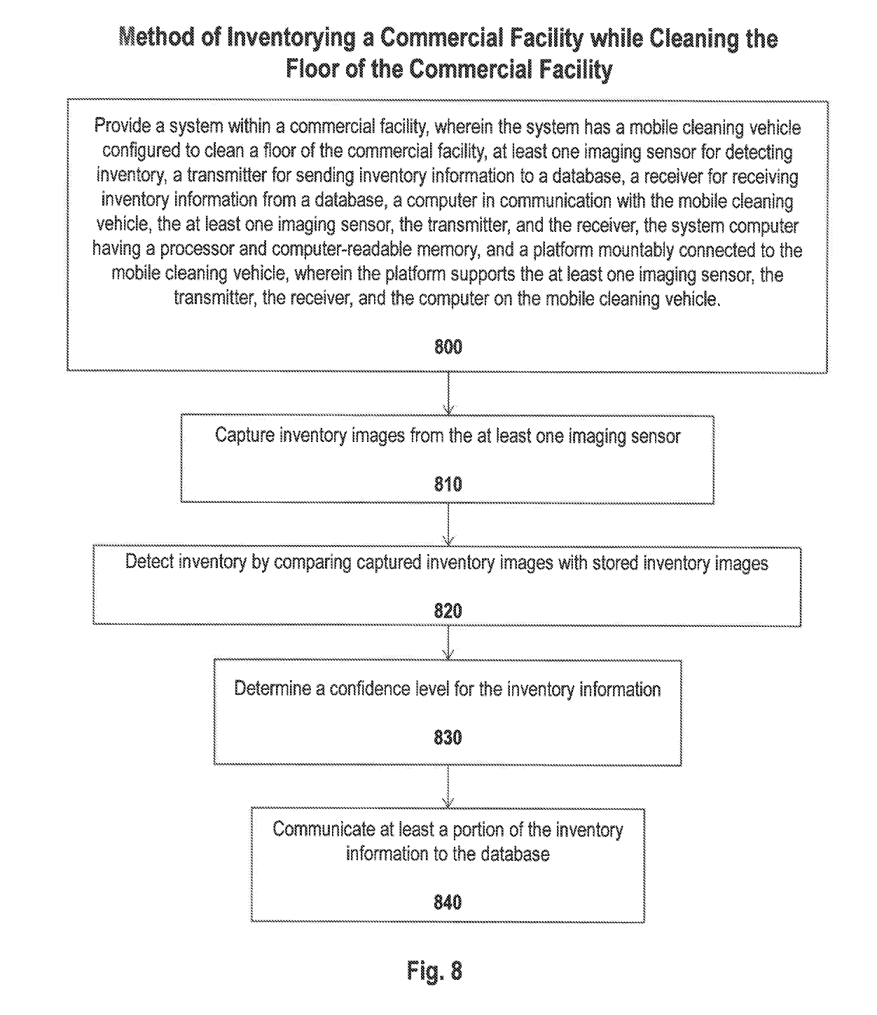

FIG. 8 is a flow chart for a method of inventorying a commercial facility while cleaning the floor of the commercial facility. As shown in block 800, a system is provided within a commercial facility, wherein the system has a mobile cleaning vehicle configured to clean a floor of the commercial facility, at least one imaging sensor for detecting inventory, a transmitter for sending inventory information to a database, a receiver for receiving inventory information from a database, a computer in communication with the mobile cleaning vehicle, the at least one imaging sensor, the transmitter, and the receiver, the system computer having a processor and computer-readable memory, and a platform mountably connected to the mobile cleaning vehicle, wherein the platform supports the at least one imaging sensor, the transmitter, the receiver, and the computer on the mobile cleaning vehicle. As shown in block 810, inventory images are captured from the at least one imaging sensor. As shown in block 820, inventory is detected by comparing captured inventory images with stored inventory images. As shown in block 830, a confidence level is determined for the inventory information. As shown in block 840, at least a portion of the inventory information is communicated to the database.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A vehicular system for performing inventory management and cleaning within a commercial facility, comprising:
a mobile cleaning vehicle configured to clean a floor of the commercial facility;
at least one imaging sensor;
a transmitter for sending inventory information to a database;
a receiver for receiving inventory information from a database; and
a computer in communication with the mobile cleaning vehicle, the at least one imaging sensor, the transmitter, and the receiver, the computer having a processor and computer-readable memory, wherein the computer is configured to:
capture inventory images from the at least one imaging sensor,
detect inventory by comparing captured inventory images with stored inventory images;
determine inventory information;
determine a confidence level for the inventory information, wherein the confidence level is determined based on at least a type of inventory items detected and a number of inventory items detected; and
communicate at least a portion of the inventory information having a confidence level above a threshold to the database.

2. The vehicular system of claim 1, wherein the at least one imaging sensor comprises at least one visible spectrum imaging sensor and at least one non-visible spectrum imaging sensor.

3. The vehicular system of claim 2, wherein the at least one visible spectrum imaging sensor is configured to capture inventory images, and wherein the at least one non-visible spectrum imaging sensor is configured to detect obstacles in a travel path of the mobile cleaning vehicle.

4. The vehicular system of claim 2, wherein the at least one visible spectrum imaging sensor and at least one non-visible spectrum imaging sensor are operated in sequence.

5. The vehicular system of claim 1, wherein the confidence level is determined by at least one factor selected from the group consisting of: captured image quality, stock status, and similarity to historic results.

6. The vehicular system of claim 1, wherein the mobile cleaning vehicle further comprises a semi-autonomous cleaning vehicle having wheels and a floor scrubbing system.

7. A system for performing automated inventory management within a commercial facility using a cleaning vehicle, comprising:
at least one imaging sensor,
a transmitter for sending inventory information to a database;
a receiver for receiving inventory information from a database;
a computer in communication with the at least one imaging sensor, the transmitter, and the receiver, the computer having a processor and computer-readable memory, wherein the computer is configured to:
capture inventory images from the at least one imaging sensor,
detect inventory by comparing captured inventory images with stored inventory images,
determine inventory information,
determine a confidence level for the inventory information, wherein the confidence level is determined based on at least a type of inventory items detected and a number of inventory items detected, and
communicate at least a portion of the inventory information having a confidence level above a threshold to the database.

8. The system of claim 7, wherein the at least one imaging sensor, the transmitter for sending inventory information to the database, and the receiver for receiving inventory information from the database are carried on a mobile cleaning vehicle having wheels and a floor-cleaning system, wherein the mobile cleaning vehicle is movable throughout at least a portion of the commercial facility.

9. The system of claim 7, comprising at least one visible spectrum imaging sensor and at least one non-visible spectrum imaging sensor.

10. The system of claim 9, wherein the at least one visible spectrum imaging sensor and at least one non-visible spectrum imaging sensor are operated in sequence.

11. The system of claim 7, wherein the confidence level is determined by at least one factor selected from the group consisting of: captured image quality, stock status, and similarity to historic results.

12. The system of claim 7, wherein the inventory information communicated to the database includes a portion of the captured inventory images at a first resolution and a portion of the captured inventory images at a second resolution, wherein the second resolution is different from the first resolution.

13. A method of inventorying and simultaneously cleaning a commercial facility with a semi or fully autonomous robotic vehicle, the method comprising:
providing a mobile cleaning vehicle within a commercial facility, the mobile cleaning vehicle being semi or fully autonomous, wherein the mobile cleaning vehicle has a locomotion platform, at least one floor cleaning system, at least one imaging sensor, a transmitter for sending inventory information to a database, a receiver for receiving inventory information from a database, and a computer in communication with the locomotion platform, the at least one imaging sensor, the transmitter, and the receiver, the computer having a processor and computer-readable memory;
capturing inventory images with the at least one imaging sensor,
detecting inventory information by comparing captured inventory images with stored inventory images;
determining a confidence level for the inventory information, wherein the confidence level is determined based on at least a type of inventory items detected and a number of inventory items detected; and
communicating at least a portion of the inventory information having a confidence level above a threshold to the database.

14. The method of claim 13, wherein the computer is configured to direct the mobile cleaning vehicle to at least one waypoint location within the commercial facility, and wherein the mobile cleaning vehicle captures the inventory images at the at least one waypoint.

15. The method of claim 14, wherein the step of detecting inventory information includes comparing the inventory images captured at a waypoint to stored inventory images captured at the same waypoint.

16. The method of claim 13, wherein the step of detecting inventory information includes at least one from the group consisting of barcode detection, label detection, and out-of-stock detection.

17. The process of claim 13, wherein the confidence level is determined by at least one factor selected from the group consisting of: captured image quality, stock status, and similarity to historic results.

18. The process of claim 13, wherein the inventory information communicated to the database includes a portion of the captured inventory images at a first resolution and a portion of the captured inventory images at a second resolution, wherein the second resolution is different from the first resolution.

19. The process of claim 13, wherein at least a portion of the step of detecting inventory information is performed by the mobile cleaning vehicle, and a portion of the step of detecting inventory information is performed by the database.

20. The process of claim 13, wherein capturing inventory images with the at least one imaging sensor occurs during a cleaning process of the commercial facility by the mobile cleaning vehicle.
